(19) United States
(12) Patent Application Publication
(10) Pub. No.: US 2011/0120666 A1
(43) Pub. Date: May 26, 2011

(54) GEO-THERMAL AND SOLAR ENERGY CONSERVATION SYSTEM UTILIZING EXPANDABLE FLUIDS AND METHODS THEREOF

(76) Inventor: James Furey, Morganville, NJ (US)

(21) Appl. No.: 12/951,753

(22) Filed: Nov. 22, 2010

Related U.S. Application Data
(60) Provisional application No. 61/263,079, filed on Nov. 20, 2009.

(51) Int. Cl. F24J 3/08; F03G 7/00

(52) U.S. Cl. 165/45; 60/641.2

(57) ABSTRACT

Embodiments of the present invention generally relate to a system for geo-thermal and solar energy conservation utilizing expandable fluids and methods thereof. More specifically, embodiments of the present invention relate to system for increasing energy efficiency in residential or commercial structures through the use of carbon dioxide in a geo-thermal environment. In one embodiment of the present invention, an energy conservation system comprises a storage container for storing a low specific heat capacity and expandable fluid; a geo-thermal piping system, extending a predetermined distance beneath a ground surface; an energy exchanger; and a structural interface positioned between the energy exchanger and an energy-consuming physical structure.

### CROSS-REFERENCE TO RELATED APPLICATIONS

This application claims priority to U.S. Provisional Patent Application Ser. No. 61/263,079, filed Nov. 20, 2009, entitled “Geo-Thermal and Solar Energy Conservation System utilizing Expandable Fluids and Methods Thereof,” the disclosure of which is incorporated herein by reference in its entirety.

### BACKGROUND

1. Field of the Invention

Embodiments of the present invention generally relate to a system for geo-thermal and solar energy conservation utilizing expandable fluids and methods thereof. More specifically, embodiments of the present invention relate to system for increasing energy efficiency in residential or commercial structures through the use of carbon dioxide in a geo-thermal environment.

2. Description of Related Art

Known geothermal systems are generally utilized to aid in the heating or cooling of a building by exploiting the general constancy of ground temperatures. One typical geothermal heating system comprises a closed loop pipe system through which water is pumped, wherein at least a portion of the pipe is disposed underground.

Many common systems comprise a bore hole is drilled into the ground into which a portion of the closed loop is placed. As the water in the pipe travels in the pipe into and out of the bore hole, the temperature of the ground surrounding the bore hole serves to either add heat to the water in the pipe or absorb heat from the water in the pipe, depending upon whether the water within the pipe is hotter or cooler than the surrounding ground temperature. Because the earth generally remains at a generally constant temperature the water passing through the pipe can, at least theoretically can be heated or cooled to this constant temperature regardless of the season. This enables the geothermal system to deliver water for use at the building that is generally at the same temperature on a year-round basis.

A significant limitation with many of these known systems derives from the use of water in its liquid form, a generally incompressible and inexpandable fluid, as a primary carrier for the thermal energy. In addition to being incompressible, water is known as having a very high specific heat capacity, and thus, it takes an exorbitant amount of energy to heat a large volume of water, for example, the volume of water needed for geo-thermal heating applications.

Accordingly, there remains a need for a geo-thermal and solar energy conservation utilizing expandable fluids and methods thereof.

### SUMMARY

Embodiments of the present invention generally relate to a system for geo-thermal and solar energy conservation utilizing expandable fluids and methods thereof. More specifically, embodiments of the present invention relate to system for increasing energy efficiency in residential or commercial structures through the use of carbon dioxide in a geo-thermal environment.

In one embodiment of the present invention, an energy conservation system comprises a storage container for storing a low specific heat capacity and expandable fluid; a geo-thermal piping system, extending a predetermined distance beneath a ground surface; an energy exchanger; and a structural interface positioned between the energy exchanger and an energy-consuming physical structure.

In another embodiment of the present invention, a method of conserving energy comprises providing a storage container for storing a low specific heat capacity and expandable fluid, a geo-thermal piping system extending a predetermined distance beneath a ground surface, an energy exchanger, and a structural interface positioned between the energy exchanger and an energy-consuming physical structure; enabling the low specific heat capacity and expandable fluid to enter the geo-thermal piping system; adding potential energy to the low specific heat capacity and expandable fluid though natural geothermal energy sources; removing the energy within the low specific heat capacity and expandable fluid via the energy exchanger; and providing energy to the energy-consuming physical structure through the structural interface.

In yet another embodiment of the present invention, an energy conservation system comprises a storage container for storing a carbon dioxide gas; a closed geo-thermal piping system, extending between about 20 to about 2,000 feet beneath the earth's surface; an additional heat exchanger, positioned beneath the earth's surface, for adding energy to the system through one of an external solar or wind energy source; a gas reaction turbine; and a structural interface positioned between the energy exchanger and an energy-consuming physical structure, wherein the structural interface comprises at least one transformer for stepping up or down voltage obtained from the energy exchanger.

### BRIEF DESCRIPTION OF THE DRAWING

So the manner in which the above recited features of the present invention can be understood in detail, a more particular description of embodiments of the present invention, briefly summarized above, may be had by reference to embodiments, which is illustrated in the appended drawing It is to be noted, however, the appended drawing illustrates only a typical embodiment of embodiments encompassed within the scope of the present invention, and, therefore, is not to be considered limiting, for the present invention may admit to other equally effective embodiments, wherein:

FIG. 1 depicts a schematic of a geo-thermal system in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the FIGURE.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present invention generally relate to a system for geo-thermal and solar energy conservation utilizing expandable fluids and methods thereof. More specifically, embodiments of the present invention relate to system for increasing energy efficiency in residential or commercial structures through the use of carbon dioxide in a geo-thermal environment.

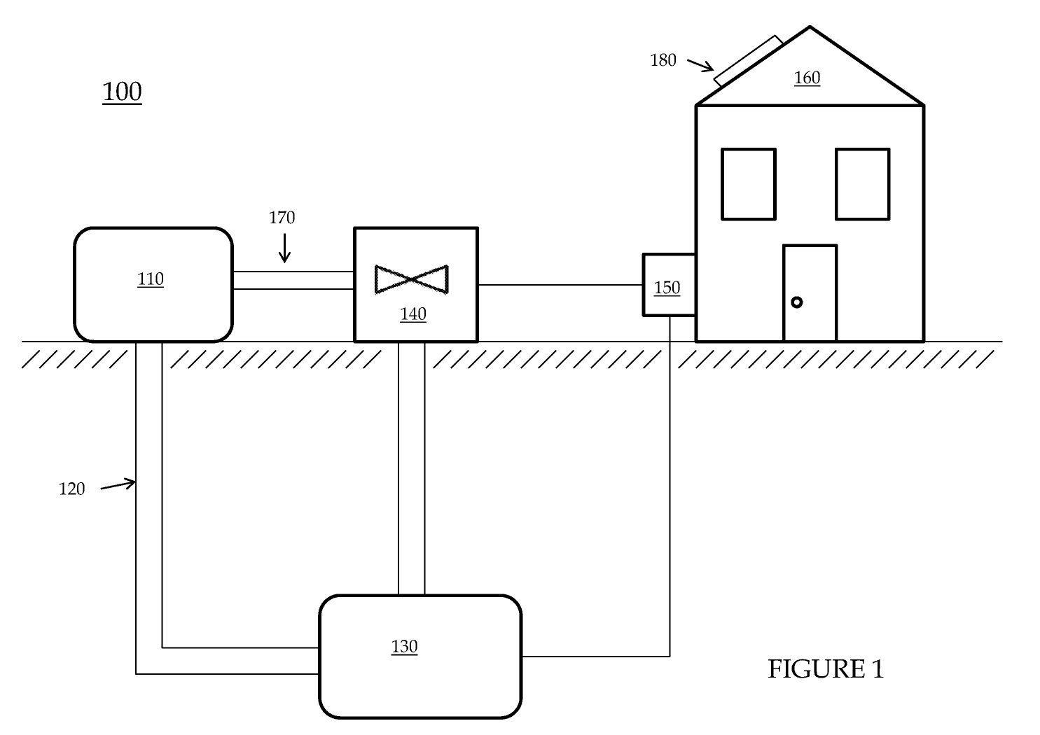

FIG. 1 depicts a schematic of a geo-thermal system in accordance with one embodiment of the present invention. A geo-thermal system 100 generally comprises a storage container 110 for storing a low specific heat capacity and expandable fluid, a geo-thermal piping system 120, an energy exchanger 140, a structural interface 150, and a commercial and/or residential structure 160. Optionally, an additional heat exchanger 130 may be utilized in connection with the geo-thermal piping system, and a solar panel 180 or similar alternative energy source may be utilized to provide additional energy to the system 100. In many embodiments, it may be desirable to provide a return pipe 170, so that the low specific heat capacity fluid may be provided in a closed system.

As used herein, a low specific heat capacity and expandable fluid (alternatively referred to as “fluid”) may comprise any liquid or gas capable having a specific heat capacity less than liquid water, or approximately 4.1813 J/(g·K), capable of volumetric expansion when exposed to certain environments. In many embodiments, the fluid may comprise a gas having a specific heat capacity less than 1.0 J/(g·K). For example, the fluid may comprise a gaseous form of argon, carbon dioxide, oxygen, or the like. In one specific embodiment, the fluid comprises carbon dioxide gas, for its thermal and volumetric expansion properties.

The storage container 110 may comprise any volumetric vessel capable of storing the fluid in accordance with embodiments of the present invention. In one embodiment, the storage container may comprise a pressure reinforced storage tank, consisting of a nonreactive material, for example, low temperature or stainless steel. The size of the storage container 110 must be sufficient to supply at least an initial amount of the fluid to the system 100 at a pressure sufficient to enter the system 100.

In certain embodiments, it may be desirable to provide a storage container 110 comprising at least a portion of a sidewall capable of allowing UV energy to pass through. In such embodiments, UV energy from the sun may be allowed to heat any fluid in the storage container 110 before entering the next portion of the system 100. Depending on the nature of the energy exchanger 140, discussed below, such a feature may increase the amount of energy to be utilized from the system 100.

The geo-thermal piping system 120 may comprise any type of piping system suitable for embodiments of the present invention. In many embodiments, the geo-thermal piping system 120 comprising a combination of one or more underground pipes and bore holes through the ground. Such broad types of geo-thermal piping systems are generally known in the industry.

In many embodiments, it may be desirable to extend the geo-thermal piping system 120 into the earth in order to expose the fluid to a particular temperature in accordance with a known geothermal gradient of the earth. In certain embodiments, the geo-thermal piping system 120 may extend between about 20 to about 2,000 feet beneath the earth's surface.

Depending on the geographic positioning of the system 100, there may an opportunity to tie the geo-thermal piping system 120 into a “hot spot” near a volcano, geyser or other naturally occurring thermal source in the earth's crust or below. Generally, in such types of hot spots, natural underground water may exist at very high temperatures. Accordingly, utilizing the thermal energy from such a source, for example, in combination with a heat exchanger 130, the fluid may be able to significantly increase its temperature and provide a substantial amount of energy to the energy exchanger 140.

In addition to increasing fluid temperature within the geo-thermal piping system 120, because of the defined volume of the piping system 120, there is a significant increase of pressure within the fluid, as known in accordance with the Ideal Gas Law. The Ideal Gas Law provides that:

pV=nRT

where p is the absolute pressure of the gas; V is the volume of the gas; n is the amount of substance of the gas, usually measured in moles; R is the gas constant (which is 8.314472 JK⁻¹ mol⁻¹ in SI units); and T is the absolute temperature.

Accordingly, because the volume and amount of gas are held constant within a closed loop system, such as the system 100, an increase in temperature is directly correlated to an increase in pressure.

Energy exchanger 140 may comprise any type of energy exchanger suitable for embodiments of the present invention. In many embodiments, the energy exchanger 140 comprises a turbine-generator, a heat exchanger, combinations thereof, or the like. In one embodiment, the energy exchanger 140 comprises a gas reaction turbine having a pressure casing surrounding a plurality of turbine blades centrally mounted on a shaft or drum. As high pressure fluid moves over the blades a mechanical rotation is imparted on the shaft. Depending on the nature of the fluid, particularly its compressibility, it may be desirable to utilize multiple turbines to minimize energy loss, as is known in the industry for compressible fluids.

Generally, where a turbine is utilized, a generator is utilized in conjunction therewith. A generator may comprise any type of power generator capable of converting rotational mechanical energy to an alternate form of energy suitable for embodiments of the present invention. In one embodiment, the generator comprises an electrical generator for converting rotational mechanical energy to electrical energy using electromagnetic induction, or similar means to convert the forms of energy.

The energy exchanger 140 may alternatively or further comprise a heat exchanger for removing the heat energy from the fluid. In such embodiments, the extracted heat energy may be converted into usable electrical energy using any known techniques, including, but not limited to a water-steam turbine, thermoelectric devices, or the like.

Once electric energy has been obtained from the energy exchanger 140, the fluid may be returned to the storage container 110 through a return pipe 170, and the energy may be processed through a structural interface 150. The structural interface 150 may comprise any type of energy monitoring or regulation device suitable for embodiments of the present invention. In many embodiments, the structural interface 150 may comprise any number of transformers for stepping up or down the voltage from the energy exchanger 140. In other embodiments, where a significant amount of energy is produced from the system 100, the structural interface may comprise a combination of transformer substations in combination with pole transformers, as is generally known with conventional residential power systems.

In yet further embodiments, the structural interface 150 may comprise any structural or electrical interfaces between any one or more of the components of the system 100 and the structure 160. For example, in certain embodiments, the system 100 may utilize the heat exchanger 130 to further heat a hot water heater within the structure 160. In such an embodiment, the structural interface 150 would comprise any necessary components, including piping for a liquid from the heat exchanger.

In alternative embodiments, the structural interface 150 may work in conjunction with an alternative power source, for example, a solar panel 180 or a wind turbine (i.e., a windmill), for providing addition energy to the system 100. In one embodiment, additional energy provided by the solar panel 180 may be utilized to provide direct energy to the structure 160, may be converted to heat to further expand the fluid after passing through the heat exchanger 130, or the like.

The structure 160 may comprise any commercial, residential, industrial, or other energy-consuming physical structure suitable for embodiments of the present invention. In many embodiments, the structure 160 comprises a building, house, warehouse, or the like, having at least one electrically powered element, device or fixture therein. In certain embodiments, the structure 160 may comprise a community, neighborhood, or other collection of multiple physical dwellings or buildings.

Although FIG. 1 depicts the structure 160 in close proximity to the other components within the system 100, embodiments of the present invention further contemplate the scale of system 100 to extend across great distances, wherein the geographic limitations are only limited by the amount of energy generated within the system 100. For example, where the structural interface 150 comprises a combination of substation and pole transformers, the structure 160 is understood to comprise a plurality of homes or buildings in a close proximity, likely miles from the geo-thermal piping system.

While the foregoing is directed to embodiments of the present invention, other and further embodiments of the invention may be devised without departing from the basic scope thereof. It should be appreciated that certain basic components of exemplary embodiments described herein have been left out of the above disclosure for sake of convenience. Such basic components (e.g., pipes, lines, connectors, valves, etc.) would be readily apparent to those of ordinary skill in the art, and the exemplary embodiments described herein would likely require many of such components to be suitable commercial embodiments in the relevant marketplace. As such, embodiments of the present invention should be considered in their entirety, inclusive of such components, as known to one of ordinary skill in the art.

What is claimed is:

1. An energy conservation system comprising:
a storage container for storing a low specific heat capacity and expandable fluid;
a geo-thermal piping system, extending a predetermined distance beneath a ground surface;
an energy exchanger; and
a structural interface positioned between the energy exchanger and an energy-consuming physical structure.

2. The energy conservation system of claim 1, wherein a low specific heat capacity and expandable fluid comprises a liquid or gas having a specific heat capacity less than approximately 4.1813 J/(g·K).

3. The energy conservation system of claim 2, wherein the low specific heat capacity and expandable fluid comprises one of argon, carbon dioxide or oxygen.

4. The energy conservation system of claim 3, wherein the low specific heat capacity and expandable fluid comprises carbon dioxide gas.

5. The energy conservation system of claim 1, wherein the storage container comprises a pressure reinforced storage tank made from a nonreactive material.

6. The energy conservation system of claim 1, wherein the geo-thermal piping system extends between about 20 to about 2,000 feet beneath the earth's surface.

7. The energy conservation system of claim 6, wherein the geo-thermal piping system is positioned to pass through a natural hot-spot underneath the earth's surface.

8. The energy conservation system of claim 1, wherein the energy exchanger comprises one of a turbine-generator, a heat exchanger, or combinations thereof.

9. The energy conservation system of claim 8, wherein the energy exchanger comprises a gas reaction turbine.

10. The energy conservation system of claim 1, wherein the structural interface comprises an energy monitoring or energy regulation device.

11. The energy conservation system of claim 10, wherein the structural interface comprises at least one transformer for stepping up or down voltage obtained from the energy exchanger.

12. The energy conservation system of claim 1, wherein the structural interface may work in conjunction with an alternative power source for providing addition energy to the system.

13. The energy conservation system of claim 1, further comprising an additional heat exchanger, positioned beneath the earth's surface, for adding energy to the system through an external energy source.

14. The energy conservation system of claim 13, wherein the additional heat exchanger comprises one of a solar energy source or a wind energy source.

15. A method of conserving energy comprising:
providing an energy conservation system comprising:
a storage container for storing a low specific heat capacity and expandable fluid, a geo-thermal piping system extending a predetermined distance beneath a ground surface;
an energy exchanger; and
a structural interface positioned between the energy exchanger and an energy-consuming physical structure;
enabling the low specific heat capacity and expandable fluid to enter the geo-thermal piping system;
adding potential energy to the low specific heat capacity and expandable fluid though natural geothermal energy sources;
removing the energy within the low specific heat capacity and expandable fluid via the energy exchanger; and
providing energy to the energy-consuming physical structure through the structural interface.

16. The method of conserving energy of claim 15, wherein the low specific heat capacity and expandable fluid comprises carbon dioxide gas.

17. The method of conserving energy of claim 15, wherein the energy exchanger comprises a gas reaction turbine.

18. The method of conserving energy of claim 15, wherein the structural interface comprises at least one transformer for stepping up or down voltage obtained from the energy exchanger.

19. The method of conserving energy of claim 15, further comprising adding additional energy to the system through an external energy source via an additional heat exchanger positioned beneath the earth's surface.

20. An energy conservation system comprising:
a storage container for storing a carbon dioxide gas;
a closed geo-thermal piping system, extending between about 20 to about 2,000 feet beneath the earth's surface;
an additional heat exchanger, positioned beneath the earth's surface, for adding energy to the system through one of an external solar or wind energy source;
a gas reaction turbine; and
a structural interface positioned between the energy exchanger and an energy-consuming physical structure, wherein the structural interface comprises at least one transformer for stepping up or down voltage obtained from the energy exchanger.
